(19) United States
(12) Patent Application Publication
(10) Pub. No.: US 2025/0094139 A1
(43) Pub. Date: Mar. 20, 2025

(54) METHOD OF GENERATING CODE BASED ON LARGE MODEL, ELECTRONIC DEVICE, AND STORAGE MEDIUM

(71) Applicant: Beijing Baidu Netcom Science Technology Co., Ltd., Beijing (CN)

(72) Inventors: Dianhai YU, Beijing (CN); Wei ZHOU, Beijing (CN); Xiang GAO, Beijing (CN); Tiezhu GAO, Beijing (CN)

(21) Appl. No.: 18/965,152

(22) Filed: Dec. 2, 2024

(30) Foreign Application Priority Data
Jun. 19, 2024 (CN) 202410792602.9

(51) Int. Cl. G06F 8/35; G06F 8/10

(52) U.S. Cl. CPC G06F 8/35; G06F 8/10

(57) ABSTRACT

A method of generating a code based on a large model, an electronic device and a storage medium are provided, which relate to the field of artificial intelligence technology, in particular to the fields of deep learning technology and large model technology. The method includes: acquiring a first descriptive text input by a user, where the first descriptive text is configured to characterize a code requirement; searching for a positive code and a negative code matching the first descriptive text, where each of the positive code and the negative code is determined based on a preference operation of the user for a historical code output by the large model; generating a second descriptive text according to the first descriptive text, the positive code, and the negative code; and inputting the second descriptive text into the large model to output a target code matching the code requirement.

### CROSS-REFERENCE TO RELATED APPLICATIONS

This application is claims priority to Chinese Application No. 202410792602.9 filed on Jun. 19, 2024, which is incorporated herein by reference in its entirety.

### TECHNICAL FIELD

The present disclosure relates to the field of artificial intelligence technology, in particular to the fields of deep learning technology and large model technology. Specifically, the present disclosure relates to a method and an apparatus of generating a code based on a large model, an electronic device, a storage medium, and a program product.

### BACKGROUND

With the continuous development of artificial intelligence technology, technologies such as a deep learning model and a large model (large language model, LLM) have also been applied in various generative fields. For example, the large model is used to assist developers in generating codes.

However, various developers often have various development styles, and their codes also reflect various styles. At present, the codes generated by the large model are difficult to meet the use needs of developers.

### SUMMARY

The present disclosure provides a method and an apparatus of generating a code based on a large model, an electronic device, a storage medium, and a computer program product.

According to an aspect of the present disclosure, a method of generating a code based on a large model is provided, including: acquiring a first descriptive text input by a user, where the first descriptive text is configured to characterize a code requirement; searching for a positive code matching the first descriptive text and a negative code matching the first descriptive text, where each of the positive code and the negative code is determined based on a preference operation of the user for a historical code output by the large model; generating a second descriptive text according to the first descriptive text, the positive code, and the negative code; and inputting the second descriptive text into the large model to output a target code matching the code requirement.

According to another aspect of the present disclosure, an apparatus of generating a code based on a large model is provided, including: an acquisition module configured to acquire a first descriptive text input by a user, where the first descriptive text is configured to characterize a code requirement; a searching module configured to search for a positive code matching the first descriptive text and a negative code matching the first descriptive text, where each of the positive code and the negative code is determined based on a preference operation of the user for a historical code output by the large model; a first generation module configured to generate a second descriptive text according to the first descriptive text, the positive code, and the negative code; and a second generation module configured to input the second descriptive text into the large model to output a target code matching the code requirement.

According to another aspect of the present disclosure, an electronic device is provided, including: at least one processor; and a memory communicatively connected to the at least one processor, where the memory stores instructions executable by the at least one processor, and the instructions, when executed by the at least one processor, cause the at least one processor to implement the method mentioned above.

According to another aspect of the present disclosure, a non-transitory computer-readable storage medium having computer instructions stored thereon is provided, where the computer instructions are configured to cause a computer to implement the method mentioned above.

According to another aspect of the present disclosure, a computer program product containing a computer program is provided, where the computer program, when executed by a processor, causes the processor to implement the method mentioned above.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to understand the present disclosure better and do not constitute a limitation to the present disclosure, in which:

FIG. 1 schematically shows an exemplary system architecture applied to a method and an apparatus of generating a code based on a large model according to the embodiments of the present disclosure;

FIG. 2 schematically shows a flowchart of a method of generating a code based on a large model according to the embodiments of the present disclosure;

FIG. 3 schematically shows a scenario of generating a code based on a large model according to an embodiment of the present disclosure;

FIG. 4A schematically shows a flowchart of searching for a positive code matching a first descriptive text and a negative code matching the first descriptive text according to an embodiment of the present disclosure;

FIG. 4B schematically shows a flowchart of searching for a positive code matching a first descriptive text according to another embodiment of the present disclosure;

FIG. 5 schematically shows a second descriptive text formed based on a prompt template according to an embodiment of the present disclosure;

FIG. 6 schematically shows a scenario of determining an editing code according to the embodiments of the present disclosure;

FIG. 7 schematically shows a scenario of determining an editing code according to the embodiments of the present disclosure;

FIG. 8 schematically shows a block diagram of an apparatus of generating a code based on a large model according to the embodiments of the present disclosure; and

FIG. 9 schematically shows a block diagram of an electronic device 900 for implementing a method of generating a code based on a large model according to the embodiments of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

In the field of deep learning, it is difficult for the large model to generate codes meeting the usage requirements of developers. To this end, in the related art, the input of the large model may be enhanced through Retrieval-Augmented Generation (RAG) technology. The RAG technology includes two main parts: information retrieval and generation. The RAG technology is mainly used to search for a domain knowledge text related to a question input by a user through an information retrieval stage, and enhance the question input by the user by using the searched domain knowledge text. For example, in the field of code generation, the traditional RAG technology may be used to enhance the question input by the user by using a text of code field knowledge.

However, the traditional RAG technology generally uses more general domain knowledge texts to enhance the user input. It is difficult to generate codes that meet the usage requirements of a specific user. In addition, generally the domain knowledge texts used in the traditional RAG technology retrieval are not included in the training corpus of the large model, which leads to inaccuracy of the code generated by the large model based on the input enhanced by RAG. For example, with the rapid development of deep learning large models, the deep learning developers may use the large model in reverse to develop codes in the field of deep learning. The field of deep learning involves a large amount of industry knowledge that is often not included in the pre-trained corpus of the large model, resulting in the inaccurate generated code.

Therefore, in order to generate an accurate code that meets a specific user code requirement, the embodiments of the present disclosure provide a method of generating a code based on a large model.

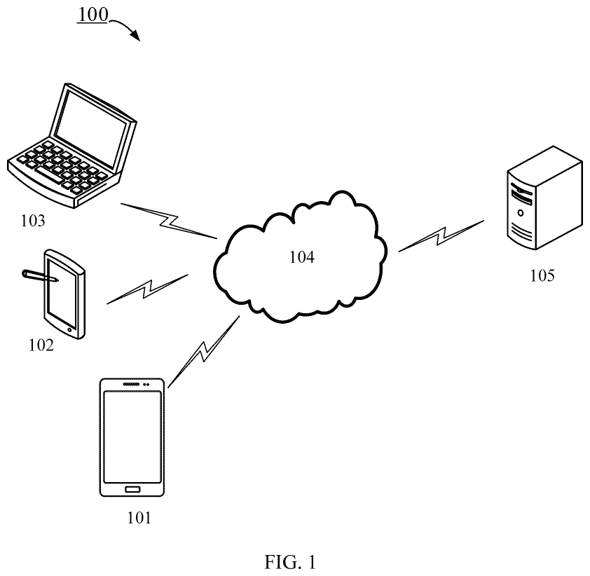

FIG. 1 schematically shows an exemplary system architecture applied to a method and an apparatus of generating a code based on a large model according to the embodiments of the present disclosure.

It should be noted that FIG. 1 is only an exemplary system architecture in which the embodiments of the present disclosure may be applied to help those skilled in the art understand the technical content of the present disclosure, but it does not mean that the embodiments of the present disclosure may not be used in other devices, systems, environments or scenarios. For example, in another embodiment, an exemplary system architecture in which the method and apparatus of generating the code based on the large model may be applied may include a terminal device. The terminal device may implement the method and apparatus provided in the embodiments of the present disclosure without interaction with the server.

As shown in FIG. 1, a system architecture 100 according to this embodiment may include a first terminal device 101, a second terminal device 102, a third terminal device 103, a network 104, and a server 105. The network 104 is used to provide a medium for communication links between the first terminal device 101, the second terminal device 102, the third terminal device 103 and the server 105. The network 104 may include various connection types, such as wired and/or wireless communication links, etc.

The user may use the first terminal device 101, the second terminal device 102, and the third terminal device 103 to interact with the server 105 through the network 104 to receive or transmit messages etc. Various communication client applications may be installed on the first terminal device 101, the second terminal device 102, and the third terminal device 103, such as knowledge reading applications, web browser applications, search applications, instant messaging tools, email clients, and/or social platform software, etc. (only examples).

The first terminal device 101, the second terminal device 102, and the third terminal device 103 may be various electronic devices with a display screen and supporting web browsing, including but not limited to smart phones, tablet computers, laptop computers, and desktop computers, etc.

The server 105 may be a server that provides various services, such as a background management server (only an example) that provides support for contents browsed by the user using the first terminal device 101, the second terminal device 102, and the third terminal device 103. The background management server may analyze and process data such as a received user request, and a processing result (for example, webpage, information, or data acquired or generated according to the user request) is fed back to the terminal device.

The server may be a cloud server, also referred to as a cloud computing server or a cloud host, which is a host product in the cloud computing service system to solve shortcomings of difficult management and weak business scalability in conventional physical host and VPS (Virtual Private Server) service. The server may also be a server of a distributed system, or a server combined with a blockchain.

It should be noted that the method of generating the code based on the large model provided in the embodiments of the present disclosure may generally be executed by the first terminal device 101, the second terminal device 102, and the third terminal device 103. Correspondingly, the apparatus of generating the code based on the large model provided by the embodiments of the present disclosure may also be generally disposed in the first terminal device 101, the second terminal device 102, and the third terminal device 103.

Alternatively, the method of generating the code based on the large model provided in the embodiments of the present disclosure may also be executed by the server 105. Correspondingly, the apparatus of generating the code based on the large model provided by the embodiments of the present disclosure may also be generally disposed in the server 105. It is also possible for the method of generating the code based on the large model provided by the embodiments of the present disclosure to be executed by a server or a server cluster, which is different from the server 105 and is capable of communicating with the first terminal device 101, the second terminal device 102, and the third terminal device 103 and/or the server 105. Correspondingly, the apparatus of generating the code based on the large model provided by the embodiments of the present disclosure may be disposed in the server or the server cluster which is different from the server 105 and is capable of communicating with the first terminal device 101, the second terminal device 102, and the third terminal device 103 and/or the server 105.

For example, when a user develops codes through the first terminal device 101, the second terminal device 102, and the third terminal device 103, the first terminal device 101, the second terminal device 102, and the third terminal device 103 may acquire a first descriptive text that is input by the user and characterizes a code requirement, and search for a positive code matching the first descriptive text and a negative code matching the first descriptive text, where the positive code and the negative code are determined based on a preference operation of the user for a historical code output by the large model through at least the above-mentioned terminal devices; generate a second descriptive text according to the first descriptive text, the positive code, and the negative code; and input the second descriptive text into the large model to output a target code matching the code requirement.

Alternatively, the user may send the first descriptive text to the server 105 and use the server 105 to search for the positive code matching the first descriptive text and the negative code matching the first descriptive text. The second descriptive text is generated according to the first descriptive text, and the positive and negative codes acquired from the server 105; and the second descriptive text is input into the large model to output the target code matching the code requirement.

Alternatively, the first terminal device 101, the second terminal device 102, and the third terminal device 103 may acquire the first descriptive text that is input by the user and characterizes the code requirement, and send the first descriptive text to the server 105. The server 105 acquires the first descriptive text that is input by the user and characterizes the code requirement; searches for the positive code matching the first descriptive text and the negative code matching the first descriptive text, where the positive code and the negative code are determined based on a preference operation of the user for a historical code output by the large model; generates the second descriptive text according to the first descriptive text, the positive code, and the negative code; and inputs the second descriptive text into the large model to output the target code matching the code requirement.

It should be understood that the numbers of terminal devices, networks and servers in FIG. 1 are merely illustrative. According to implementation needs, there may be any number of terminal devices, networks and servers.

In the technical solution of the present disclosure, the collection, storage, use, processing, transmission, provision, disclosure, and application of user personal information involved comply with relevant laws and regulations, necessary confidentiality measures have been taken, and do not violate public order and good customs.

In the technical solution of the present disclosure, authorization or consent has been acquired from the user before acquiring or collecting the user personal information.

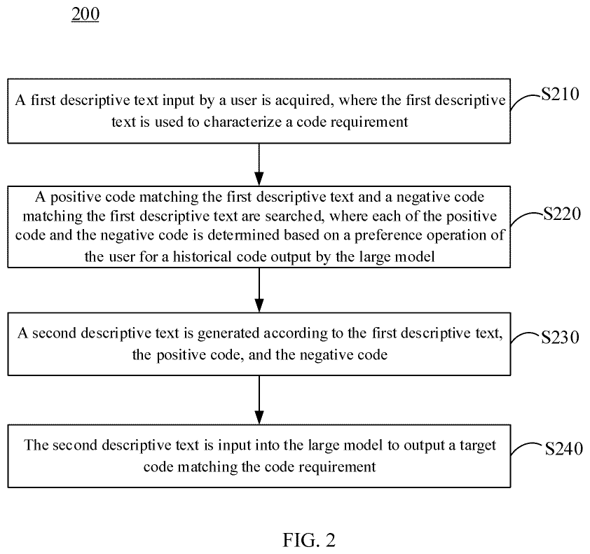

FIG. 2 schematically shows a flowchart of a method of generating a code based on a large model according to the embodiments of the present disclosure. As shown in FIG. 2, the method includes operations S210 to S240.

In operation S210, a first descriptive text input by a user is acquired, where the first descriptive text is used to characterize a code requirement.

The first descriptive text may represent the code requirement of the user, that is, a usage requirement. Specifically, the first descriptive text may include at least one of: functional description information, syntax description information, a personalized coding style requirement, etc.

The first descriptive text input by the user differs from the code output by the large model. It may be understood that the code usually has a strict syntax requirement, such as a defining parameter type, a calling statement, a calling order, a return value, a function format, etc. However, the first descriptive text is mainly used to describe the code requirement of the user and may be a natural descriptive language with various styles, such as the more colloquial natural descriptive language: “What style of code do you want”, “What function of code do you want”, etc.

For example, for a code generation task in the field of deep learning, the first descriptive text may include: a description of the deep learning function, a specified deep learning framework, etc., so that the large model may automatically generate a corresponding deep learning code.

In operation S220, a positive code matching the first descriptive text and a negative code matching the first descriptive text are searched, where each of the positive code and the negative code is determined based on a preference operation of the user for a historical code output by the large model.

Both the positive code and the negative code are historical codes output by the large model, and may be considered as categories of the historical codes output by the large model. For example, if the first descriptive text is input by a user who has previously used the large model and performed a preference operation on a historical code output by the large model, the category of the historical code may be determined as the positive code or the negative code.

The positive code is determined based on a positive preference operation of the user for the historical code output by the large model, while the negative code is determined based on a negative preference operation of the user for the historical code output by the large model. The positive preference operation characterizes an operation associated with a positive tendency such as liking, while the negative preference operation characterizes an operation associated with non-positive tendencies such as disliking and neutrality.

Searching for the positive code matching the first descriptive text and the negative code matching the first descriptive text includes: calculating the positive code matching the first descriptive text and the negative code matching the first descriptive text based on a similarity. The similarity includes: a similarity between a first vector converted from the first descriptive text and a second vector converted from the positive code, and a similarity between the first vector and a third vector converted from the negative code.

In the embodiments of the present disclosure, the natural language processing (NLP) technology may be used for the vector conversion of text/code. Considering the code may be considered as a text written in English and the first descriptive text may be a text written in Chinese and/or English, the model such as Bert may be used to convert the first descriptive text, the positive code, and the negative code into vectors. Similarity calculation may be based on at least one of the following similarity measurements: cosine similarity, inner product, Euclidean distance, etc.

In addition, for each coding process of the large model, there is a one-to-one mapping relationship between the output of the large model and the input of the large model. Therefore, the input of the large model may be used to search for the positive code matching the first descriptive text and the negative code matching the first descriptive text. The input of the large model here may be a user input or an input enhanced using RAG technology.

In operation S230, a second descriptive text is generated according to the first descriptive text, the positive code, and the negative code.

In the embodiments of the present disclosure, the second descriptive text may be generated by combining the first descriptive text, the positive code, and the negative code. Alternatively, the second descriptive text may also be generated by cropping, concatenating, and filling of the first descriptive text, the positive code, and/or the negative code.

From the perspective of the input of the large model, the actual input of the large model is referred to as the second descriptive text, which is a text obtained by enhancing the first descriptive text. In essence, the second descriptive text may include both input dimension information such as the first descriptive text, and output dimension information such as positive and negative codes.

The first descriptive text is the information input by the user in the current code generation stage, and the positive and negative codes are outputs of the large model obtained by the same user in at least one historical code generation process. Therefore, in each code generation process, by integrating the first descriptive text that is related to the input with the positive and negative codes that are related to the output and reflects the personalized characteristics of the user, the input of the large model may be further personalization-enhanced from the perspective of the historical output of the large model, so as to obtain the personalization-enhanced second descriptive text for the same user.

In operation S240, the second descriptive text is input into the large model to output a target code matching the code requirement.

The large model may be a generation-type large model, a conversation-type large model, etc., as long as it may output the target code according to the prompt information in the second descriptive text.

For the target code output by the large model, since the positive and negative codes are determined according to the preference operations of the same user for historical codes, the positive and negative codes obtained from the search may be considered as the enrichment and enhancement of the first descriptive text characterizing the code requirement, so that the large model outputs the code which is more in line with the code requirement. Therefore, the target code may be understood as a target code matching the code requirement.

In the embodiments of the present disclosure, both the positive and negative codes are historical codes obtained by the same user using the same large model. Accordingly, the positive and negative codes may represent the preference of the user, so that the large model may be guided better based on the preference of the same user and output the personalized code corresponding to the user. In addition, both the positive and negative codes are used as historical outputs of the large model, which may to some extent reflect the internal generation logic of the large model. Therefore, the second descriptive text, which is generated according to the current first descriptive text input by the user, the positive code, and the negative code, may reflect the preference and the coding style of the current user in a personalized manner, guide the large model to output the code with user characteristics, achieving the effect of “the more it is used, the better it is used”. Furthermore, the first descriptive text may be enhanced through the historical outputs (positive and negative codes), compensating for the accuracy issue caused by the retrieval text not being included in the training corpus of the large model during the traditional RAG enhancement, and improving the code generation accuracy of the large model.

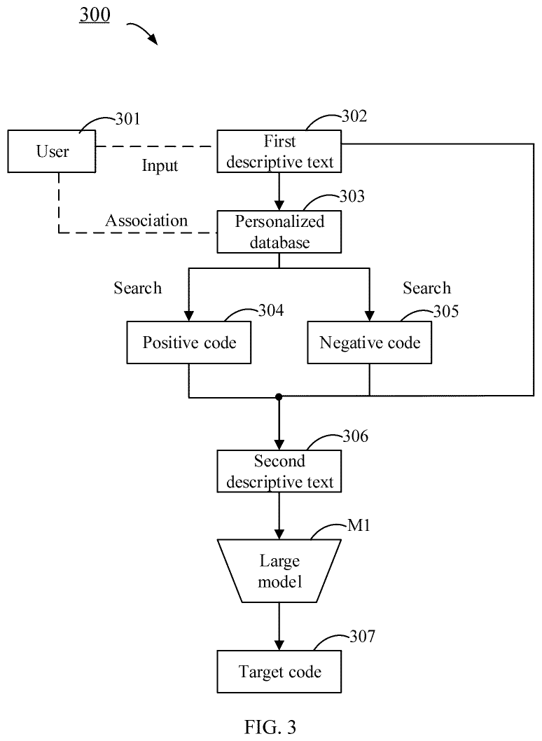

Referring to FIG. 3 to FIG. 6, further explanation of the method shown in FIG. 2 will be provided in conjunction with specific embodiments.

FIG. 3 schematically shows a scenario of generating a code based on a large model according to an embodiment of the present disclosure.

As shown in FIG. 3, in a scenario of generating a code of an embodiment 300, a user 301 may input a first descriptive text 302 characterizing a code requirement, for example, “I want a loop statement written in syntax A, and the condition for loop is xxx”. In addition, the user 301 is associated with a personalized database 303. The personalized database 303 associated with the user 301 includes at least one historical code output by a large model M1 used by the user 301 previously, and this historical code is further determined as a positive code or a negative code according to a preference operation of the user 301.

It should be noted that, for each user using the large model M1, the large model M1 enhances the first descriptive text for each input based on the historical usage information of the user by using the personalized database associated with each user, without fine-tuning for each user. As the user continuously use the large model M1, the personalized database associated with the user are continuously enriched, achieving RAG self-feedback enhancement at the user granularity. As a result, the more times the user uses the large model M1, the more positive and negative codes representing the preferred style of the user are generated, resulting in increased accuracy in searching for the positive and negative codes matching the first descriptive text for each input. In this way, it is achieved an effect of “the more it is used, the better it is used” at the user granularity.

After the user 301 inputs the first descriptive text 302, a positive code 304 matching the first descriptive text 302 and a negative code 305 matching the first descriptive text 302 may be searched from the personalized database 303 associated with the user 301. Then, a second descriptive text 306 is generated according to the first descriptive text 302, the positive code 304 matching the first descriptive text 302, and the negative code 305 matching the first descriptive text 302. Compared to the first descriptive text 301, the second descriptive text 306 achieves personalized enhancement for the user in terms of large model historical output and user preference.

After inputting the second descriptive text 306 into the large model M1, the large model M1 outputs the target code 307 matching the code requirement.

According to the embodiments of the present disclosure, searching for a positive code matching the first descriptive text and a negative code matching the first descriptive text includes: searching for at least one historical descriptive text similar to the first descriptive text from a personalized database associated with the user; determining at least one initial positive code associated with the at least one historical descriptive text and at least one initial negative code associated with the at least one historical descriptive text; and selecting at least one positive code and at least one negative code from the at least one initial positive code and the at least one initial negative code, respectively.

In the embodiments of the present disclosure, the method of generating the code based on the large model may include operations S210, S230 and S240, and operation S220 may be performed in the above implementation manner.

For each processing process of the large model, the input and output of the large model usually have a one-to-one mapping relationship, that is, one input corresponds to one output. However, for a plurality of processing processes of the entire large model, the same input may result in the same or different outputs. Therefore, the historical descriptive text, which is used as the input of the large model, may be associated with at least one initial positive code and/or at least one initial negative code.

Therefore, the historical descriptive text corresponding to the positive code and the negative code may be used to indirectly search for the positive code and the negative code that match the first descriptive text.

The historical descriptive text and the first descriptive text are texts describing different code requirements for the same user. It may be understood that the historical descriptive text and the first descriptive text have the same expression style of the user. Therefore, when searching for at least one historical descriptive text similar to the first descriptive text, the search difference caused by different expression styles may be reduced.

In the embodiments of the present disclosure, searching for at least one historical descriptive text similar to the first descriptive text from the personalized database associated with the user includes: searching for one or more historical descriptive texts similar to the first descriptive text from the personalized database associated with the user according to the similarity level or the similarity threshold.

The similarity between the first descriptive text and the historical descriptive text may be calculated through a plurality of text similarity calculation methods, including but not limited to the following methods. As an example of text similarity calculation method, the first descriptive text and the historical descriptive text are converted into the first vector and the fourth vector respectively, and the similarity between the first vector and the fourth vector is used as the similarity between the first descriptive text and the historical descriptive text. As another example of text similarity calculation method, each of the first descriptive text and the historical descriptive text is segmented into words, a set of keywords are extracted from the words of each of the first descriptive text and the historical descriptive text, the similarity between the set of keywords corresponding to the first descriptive text and the set of keywords corresponding to the historical descriptive text is calculated as the similarity between the first descriptive text and the historical descriptive text. As yet another example of text similarity calculation method, the similarity between the first descriptive text and the historical descriptive text may be calculated by using a text comparison model, such as the n-gram language model, the TF-IDF model, the topic model (Latent Dirichlet Allocation, LDA), etc.

Determining at least one initial positive code associated with at least one historical descriptive text and at least one initial negative code associated with at least one historical descriptive text, includes: for a historical descriptive text similar to the first descriptive text, determining at least one initial positive code associated with the historical descriptive text and/or at least one initial negative code associated with the historical descriptive text; and integrating the at least one initial positive code and/or at least one initial negative code of each of at least one historical descriptive text, so as to obtain at least one initial positive code and at least one initial negative code. In this embodiment, for the same historical descriptive text, both the initial positive code and the initial negative code may be selected to enhance the preference discrimination of the user for the same historical descriptive text. Alternatively, for the same historical descriptive text, the initial positive code or the initial negative code may be selected.

In the embodiments of the present disclosure, for at least one initial positive code, at least one positive code may be selected from the at least one initial positive code based on the similarity between the initial positive code and the first descriptive text. For at least one initial negative code, at least one negative code may be selected from the at least one initial negative code based on the similarity between the initial negative code and the first descriptive text.

Alternatively, at least one initial positive code may be directly used as at least one positive code, and at least one initial negative code may be directly used as at least one negative code.

Alternatively, the code annotation text for the initial positive code may be acquired, and at least one positive code may be selected from at least one initial positive code based on the similarity between the code annotation text and the first descriptive text. Furthermore, the code annotation text for the initial negative code may be acquired, and at least one negative code may be selected from at least one initial negative code based on the similarity between the code annotation text and the first descriptive text.

In the embodiments of the present disclosure, at least one positive code and at least one negative code are indirectly searched from the personalized database associated with the user based on the perspective of the input (historical descriptive text) of the large model, reducing search differences caused by different expression styles between users and differences in the descriptive syntax between the code and the descriptive text, improving the search accuracy, thereby improving the matching degree between the enhanced second descriptive text and the code requirement, which helps the large model output the target code that is more in line with the user characteristic. In addition, the selecting operation of the initial positive code and the initial negative code may further improve the matching degree between the positive and negative codes and the code requirement, thereby further improving the matching degree between the enhanced second descriptive text and the code requirement, which helps to improve the accuracy of the output of the large model.

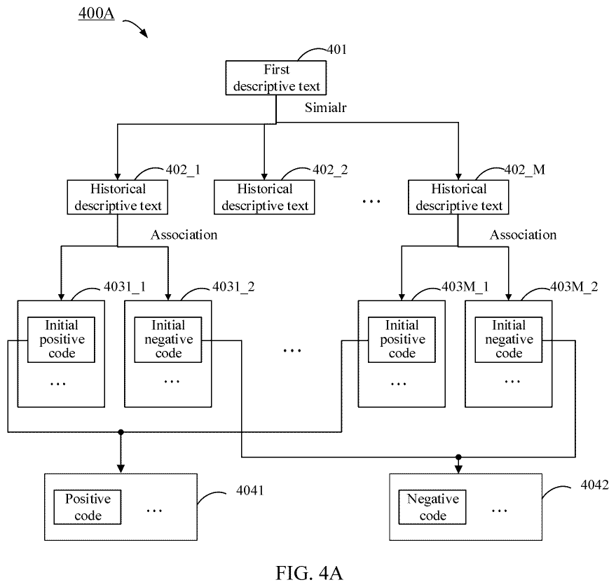

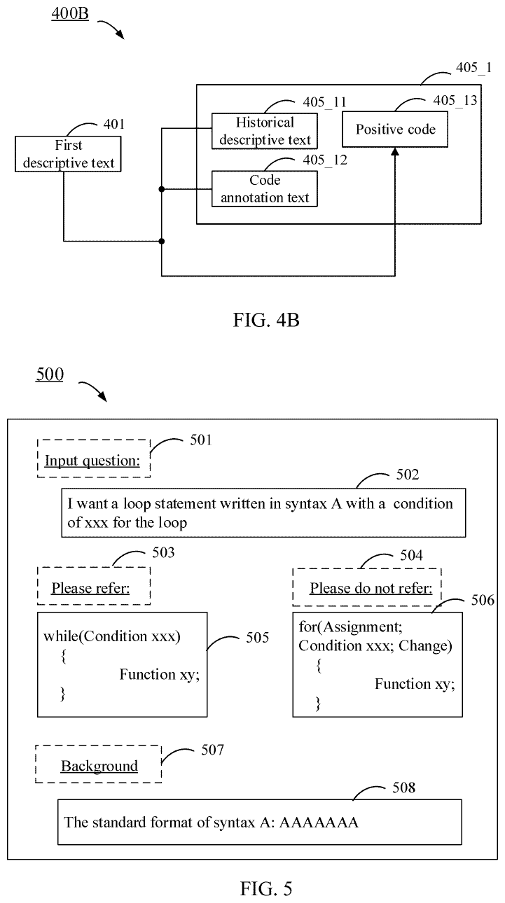

FIG. 4A schematically shows a flowchart of searching for a positive code matching a first descriptive text and a negative code matching the first descriptive text according to an embodiment of the present disclosure.

As shown in FIG. 4A, in an embodiment 400A, a plurality of historical descriptive texts, such as a historical descriptive text 402_1, a historical descriptive text 402_2, . . . , and a historical descriptive text 402_M, that are similar to the first descriptive text 401 may be determined based on a similarity between the first descriptive text 401 and each historical descriptive text in the personalized database. Each historical descriptive text may be associated with at least one initial positive code and at least one initial negative code. For example, the historical descriptive text 402_1 is associated with at least one initial positive code 4031_1 and at least one initial negative code 4031_2, . . . , and the historical descriptive text 402_M is associated with at least one initial positive code 403M_1 and at least one initial negative code 403M_2.

Based on the similarity, at least one positive code 4041 may be selected from at least one initial positive code associated with each historical descriptive text, and at least one negative code 4042 may be selected from at least one initial negative code associated with each historical descriptive text.

According to the embodiments of the present disclosure, searching for a positive code matching the first descriptive text and a negative code matching the first descriptive text includes: searching for at least one positive sample similar to the first descriptive text and at least one negative sample similar to the first descriptive text from a personalized database associated with the user, according to a historical descriptive text and a code annotation text included in each of the positive sample and the negative sample; and determining the positive code and the negative code according to a positive code included in each of the at least one positive sample and a negative code included in each of the at least one negative sample.

In the embodiments of the present disclosure, the method of generating the code based on the large model may include operations S210, S230 and S240, and operation S220 may be performed in the above implementation manner.

In the embodiments of the present disclosure, the personalized database includes positive samples and negative samples, both of which are in the form of text pairs. The positive/negative sample includes: a historical descriptive text as an input of the large model, a positive/negative sample as an output of the large model, and a code annotation text for the positive/negative sample.

The personalized database is a historical summary of programming experience, professional knowledge, programming preference, and style of a certain user, which may depict a “thousands of people, thousands of faces” user profile, in order to achieve a more accurate and customized code generation effect based on the personalized database.

The code annotation text may be included in the positive or negative code, separated from the code by an annotation symbol. The code annotation text is used to annotate the functionality, definition information, object format information, or parameter information of each line of code, such as an input parameter, an output parameter, etc. Alternatively, the code annotation text may also be included separately in the positive or negative sample to annotate the overall functionality, definition information, object format information, or parameter information of the positive or negative code.

The code annotation text is used to enhance the readability of code. Generally, similar to the first descriptive text, the code annotation text may be in natural descriptive language with a plurality of description styles.

In the embodiments of the present disclosure, the historical descriptive text and the code annotation text may be concatenated to obtain a concatenated text, and at least one positive sample similar to the first descriptive text and at least one negative sample similar to the first descriptive text may be searched for according to the similarity between the concatenated text and the first descriptive text. Alternatively, it is possible to search for at least one initial positive sample and at least one initial negative sample based on the similarity between the historical descriptive text (code annotation text) and the first descriptive text; and select at least one positive sample and at least one negative sample from at least one initial positive sample and at least one initial negative sample based on the similarity between the code annotation text (historical descriptive text) and the first descriptive text.

Then, the positive code included in each of at least one positive sample may be determined as the positive code matching the first descriptive text, and the negative code included in each of at least one negative sample may be determined as the negative code matching the first descriptive text.

In the embodiments of the present disclosure, the code annotation text similar to the first descriptive text is introduced, and both the first descriptive text and the code annotation text are used as a basis for searching for the positive sample and the negative sample. From the perspective of the input (such as the historical descriptive text) of the large model and the output (such as the code annotation text) of the large model, the search accuracy for determining the positive sample and the negative sample is improved.

FIG. 4B schematically shows a flowchart of searching for a positive code matching a first descriptive text according to another embodiment of the present disclosure.

As shown in FIG. 4B, in an embodiment 400B, the personalized database may include a plurality of positive samples and a plurality of negative samples. For example, a positive sample 405_1 includes a historical descriptive text 405_11, a code annotation text 405_12, and a positive code 405_13.

It may be determined whether the positive code 405_13 is the positive code matching the first descriptive text 401 based on the similarity between the concatenated text obtained by concatenating the historical descriptive text 405_11 and the code annotation text 405_12 and the first descriptive text 401.

According to the embodiments of the present disclosure, generating a second descriptive text according to the first descriptive text, the positive code, and the negative code includes: acquiring a first prompt word, a positive prompt word, and a negative prompt word; and combining, based on a prompt template, the first prompt word, the positive prompt word, the negative prompt word, the first descriptive text, the positive code, and the negative code to obtain the second descriptive text.

In the embodiments of the present disclosure, the method of generating the code based on the large model may include operations S210, S220 and S240, and operation S230 may be performed in the above implementation manner.

The first prompt word is related to the first descriptive text. The positive prompt word is related to the positive code. The negative prompt word is related to the negative code.

The prompt template may be a pre-built prompt template used to guide the large model. In this embodiment, the positive prompt word and the negative prompt word have identifiable positive or negative tendencies to guide the large model to refer to the positive code related to the positive prompt word and the negative code related to the negative prompt word, so as to generate the target code.

The positive prompt word and the negative prompt word may be pre-defined, for example, pre-defined in a prompt word library. Alternatively, the positive prompt word and the negative prompt word may also be extracted from the first descriptive text. Alternatively, the positive prompt word and the negative prompt word may also be obtained through the supplementation from the prompt word library in a case where no prompt word is extracted from the first descriptive text or only the positive or negative prompt word is extracted from the first descriptive text.

In the embodiments of the present disclosure, the prompt template may further have a preset format, in which a positional relationship between the first prompt word and the first descriptive text, a positional relationship between the positive prompt word and the positive code, and a positional relationship between the negative prompt word and the negative code are indicated, so that the first prompt word, the positive prompt word, the negative prompt word, the first descriptive text, the positive code, and the negative code may be filled in corresponding positions of prompt template, facilitating the rapid generation of the second descriptive text.

In addition, the prompt template may be directly filled with the first descriptive text, the positive code, and the negative code. The first descriptive text, the positive code, or the negative code may also be processed such as cropped, supplemented, etc., and then the prompt template may be filled with the processed first descriptive text, the processed positive code, or the processed negative code.

According to the embodiments of the present disclosure, the method of generating the code based on the large model may include operations S210 to S240. Before the operation S240, the method may further include: searching for a text of code field knowledge that matches the first descriptive text from the personalized database; and updating the second descriptive text by using the text of code field knowledge and a second prompt word.

In the embodiments of the present disclosure, in addition to enhancing the first descriptive text using the positive code and the negative code, the first descriptive text may be enhanced based on background knowledge in the field of code generation. Specifically, the text of code field knowledge includes but is not limited to such as textbooks, tutorials, and interface documents or other texts containing knowledge in the field of code.

The personalized databases associated with different users may include generalized knowledge in the field of code, and positive and negative codes which have been personalized after the users use the large model.

In the embodiments of the present disclosure, a similarity between the first descriptive text and the domain knowledge text may be calculated. Based on the similarity, at least one text of code field knowledge that matches the first descriptive text may be searched from the personalized database. Alternatively, the searching may be performed in other databases that store texts of knowledge in general fields, rather than the personalized database associated with the user.

The above prompt template may further include a second prompt word related to the text of knowledge in field. Therefore, the prompt template may be filled with the text of code field knowledge which is obtained by searching, so as to generate an updated second descriptive text. The determination method of the second prompt word is similar to that of the first prompt word, which will not be repeated here.

In some other embodiments, generating the second descriptive text according to the first descriptive text, the positive code, and the negative code includes: searching for at least one text of code field knowledge matching the first descriptive text, and forming the second descriptive text according to the first descriptive text, the text of code field knowledge, the positive code, the negative code, the first prompt word, the second prompt word, the positive prompt word, and the negative prompt word.

In the embodiments of the present disclosure, the text of code field knowledge is introduced. By using the first descriptive text that acts as the input of the large model, positive and negative codes with preferences that act as the historical output of the large model, and the text of code field knowledge related to the field background, the personalization and content richness of the second descriptive text are enhanced. This facilitates to guide the large model to output the target code that is more user specific, meets user needs, and more accurate.

FIG. 5 schematically shows a second descriptive text formed based on a prompt template according to an embodiment of the present disclosure.

As shown in FIG. 5, the prompt template may include: a first prompt word 501, a second prompt word 507, a positive prompt word 503, and a negative prompt word 503. The first prompt word 501 may be “input text”, the second prompt word 507 may be “background”, the positive prompt word 503 may be “please refer”, and the negative prompt word 503 may be “please do not refer”.

A first descriptive text 502 input by the user may be, for example, “I want a loop statement written in syntax A with a condition of xxx for the loop”. A positive code 505 may be, for example, “while (condition xxx) {function xy;}”. A negative code 506 may be, for example, “for (assignment; condition xxx; change) {function xy;}”. A text of code field knowledge 508 may be, for example, “The standard format of syntax A: AAAAAAA”.

The second descriptive text may be obtained by combining the prompt words and filling content in the filled prompt template.

In the embodiments of the present disclosure, the user may input the historical descriptive text and input the personalization-enhanced historical descriptive text into the large model to output the historical code. The user may classify the historical codes output by the large model into positive and negative codes through a preference operation.

According to the embodiments of the present disclosure, for the historical code output by the large model, determining the positive code and the negative code includes: determining the historical code as the negative code associated with the historical code according to a first preference selection operation of the user for the historical code; determining the historical code as the positive code associated with the historical code according to a second preference selection operation of the user for the historical code; and storing the positive code or the negative code in a personalized database associated with the user.

In the embodiments of the present disclosure, the first preference selection operation, also known as a negative preference operation, may be operations such as discarding, closing, or canceling the target code. The second preference selection operation, also known as a positive preference operation, may be operations such as selecting, copying, or confirming the target code.

In the embodiments of the present disclosure, the positive code or the negative code may be the complete code output by the large model. Alternatively, the positive code or the negative code may also be a partial code obtained by truncating the complete code output by the large model.

When storing the positive code or the negative code, the positive code or the negative code may be stored associated with the historical descriptive text of the current input, so that the large model may quickly search for the positive code matching the first descriptive text and the negative code matching the first descriptive text based on the historical descriptive text during a subsequent personalized enhancement operation.

By repeatedly using the large model, personalized data is continuously supplemented to the personalized database by using the preference operation of the user, thereby achieving self-feedback enhancement of the personalized database. Compared to the traditional RAG technology that rarely updates the retrieval database or only supplements the generic domain information, the code generation effect of the large model may be effectively enhanced in the embodiments of the present disclosure in the self-feedback enhancement manner.

In the embodiments of the present disclosure, it is considered that both the historical code output by the large model based on the historical descriptive text and the target code output by the large model based on the first descriptive text may not fully meet the code requirement. However, the historical code or the target code may be edited into the code that meets the code requirement through the simple editing operation of the user. Therefore, after the user performs a second preference selection operation on the historical code, the editing operation may be performed on the historical code to optimize the positive code fed back to the personalized database.

According to another embodiment of the present disclosure, determining the positive code and the negative code further includes: determining the historical code determined based on the second preference selection operation as an initial positive historical code; and determining an editing code according to an editing operation of the user for the initial positive historical code, and determining the editing code as the positive code.

The code output by the large model in the field of deep learning or other domains is usually a framework-type code. Therefore, the editing operation of the user is usually an insertion operation, that is, inserting a detailed code such as a parameter and a function based on the output of the large model. In addition, the editing operation may also an operation such as modifying or deleting the output of the large model.

Determining the editing code according to the editing operation of the user for the initial positive historical code includes: determining a code at a position targeted by the editing operation as the editing code. For example, the editing code may be determined by comparing codes before and after the editing operation line by line.

In the embodiments of the present disclosure, the editing code may be determined through the editing operation of the user, and the editing code may be used as the positive code, so as to incorporate the positive code that improves towards the code requirement of the user without fine-tuning the large model. In this way, the matching degree between the subsequent output of the large model and the code requirement of the user may be improved at a lower cost, thereby improving the user experience.

According to the embodiments of the present disclosure, determining an editing code according to an editing operation of the user for the initial positive historical code includes: determining an editing position where the editing operation begins and determining a code feature of the initial positive historical code after the editing position; acquiring, in response to determining that the user ends the editing operation, an intermediate positive historical code at a time instant where the user ends the editing operation; and determining the editing code according to the code feature and the intermediate positive historical code.

The user usually needs some time to perform the editing operation on the initial positive historical code. Therefore, when beginning the editing operation, the editing position where the editing operation begins and the code feature of the initial positive historical code after the editing position may be determined. Specifically, the initial positive historical code output by the large model may be used as the basis for the user to generate the editing operation, and the editing position where the editing operation begins may be determined according to the interaction between the user and the terminal device.

The editing position where the editing operation begins may be represented by the number of lines of code, the target line of code targeted by the editing operation, etc.

The editing position may be used to divide the initial positive historical code into two parts, namely an initial positive historical code located before the editing position and an initial positive historical code located after the editing position. Since the editing position where the editing operation begins is usually the beginning position of the editing code, the ending position of the editing code may be determined according to the initial positive historical code located after the editing position, so that the initial positive historical code between the beginning position and the ending position is used as the editing code.

The code feature of the initial positive historical code located after the editing position is used to locate the ending position of the editing code. Specifically, the code feature may be the initial positive historical code itself located after the editing position. Alternatively, the code feature may also be the number of lines of the initial positive historical code located after the editing position. Alternatively, the code feature may also be the first line of code located after the editing position.

Determining that the user ends the editing operation includes: determining that the user ends the editing operation in response of receiving an interactive operation of the user on a preset control, such as a clicking operation on a “submit” control; or determining that the user ends the editing operation after a preset duration. The preset duration may be determined based on the historical editing duration of the current user. It may be considered that after the preset duration, the user has completed the editing operation on the initial positive historical code. The preset duration is between the beginning time of the editing operation and the ending time of the editing operation.

For the method of determining that the editing operation is ended based on the preset duration, the intermediate positive historical code may be recorded in a user insensitive manner without the user operation.

After determining the intermediate positive historical code, the end position of the editing code may be located according to the code feature and the intermediate positive historical code. Therefore, the initial positive historical code between the begin position and end position may be determined as the editing code.

For example, for an initial positive historical code consisting of 10 lines of code, the editing position may be the second line, and the code feature of the initial positive historical code after the editing position is 8 lines, that is, the remaining 8 lines. The intermediate positive historical code obtained after the editing operation of the user consists of 12 lines, and the ending position of the editing operation determined based on the code feature and the intermediate positive historical code is the 4th line or the 9th to last line. Therefore, the second, third, and fourth lines of code are used as the editing code.

In the embodiments of the present disclosure, the editing code is determined according to the code feature of the initial positive historical code after the editing position and the intermediate positive historical code, which may quickly locate the editing code. In addition, by using the editing code unlearned by the large model as the positive code, the editing code of the user may be self-fed-back and enhanced into the personalized database, which helps to store fewer and more effective positive codes and guide the large model to generate the more accurate code according to a shorter second descriptive text.

In the embodiments of the present disclosure, the user may also perform the preference operation on the target code output by operation S240, so as to generate the positive or negative code according to the target code. In addition, the first descriptive text, and positive or negative code in this code generation process are self-fed-back to the personalized database, so as to better enhance the user input for the next code generation process.

Similarly, the method of determining the positive code and the negative code according to the target code is similar to the method of determining the positive code and the negative code according to the historical code, which will not be repeated here.

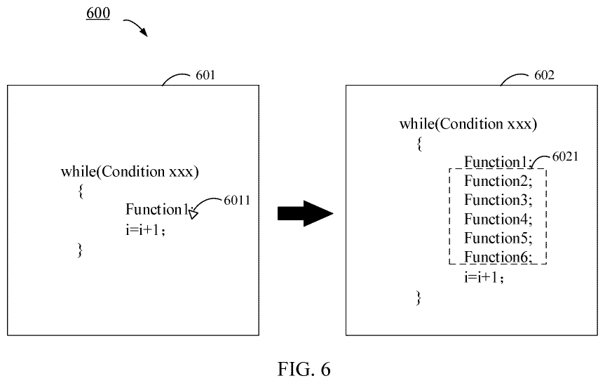

FIG. 6 schematically shows a scenario of determining an editing code according to the embodiments of the present disclosure.

As shown in FIG. 6, a scenario 600 includes an initial positive historical code 601 and an intermediate positive historical code 602. The user begins the editing operation at the third line of the initial positive historical code 601 by operating a cursor 6011, that is, the editing position is the third line. The code feature of the initial positive historical code after the editing position may be 2 lines, that is, the remaining two lines.

After a preset duration, such as 3 minutes, the intermediate positive historical code 602 at a time instant where the user ends the editing operation is acquired. An editing code 6021 is determined by comparing the code feature with the intermediate positive historical code 602.

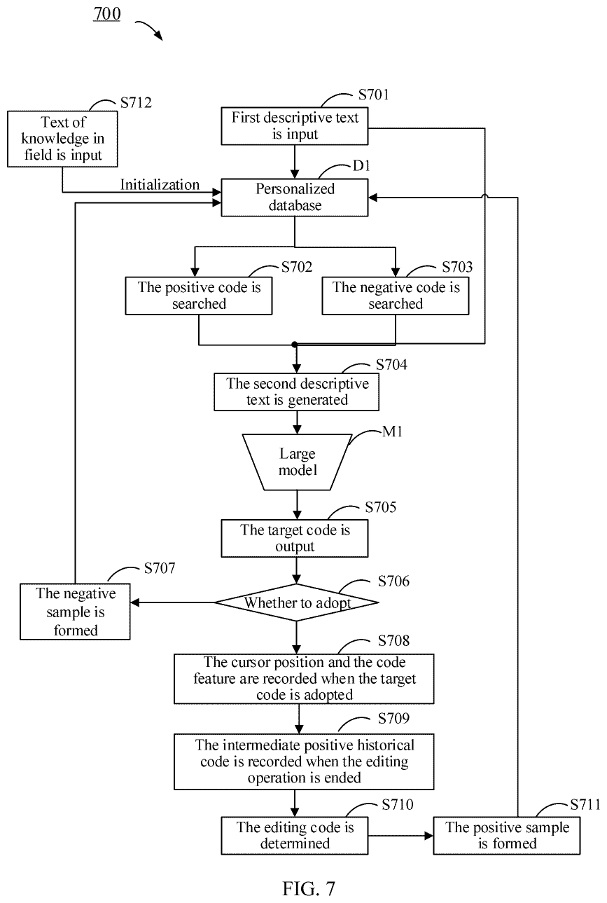

To facilitate understanding of the implementation method of the present disclosure, an alternative implementation scheme will be described using code generation in the field of deep learning as an example, shown in FIG. 7.

FIG. 7 schematically shows a scenario of determining an editing code according to the embodiments of the present disclosure.

In operation S701, a first descriptive text is input. The user may input the first descriptive text characterizing a code requirement in the field of deep learning. A personalized database D1 associated with the user includes a text of code field knowledge in the field of deep learning, as well as positive and negative codes of the large model M1 used by the user previously.

In operation S702, the positive code is searched. For example, the positive code matching the first descriptive text may be searched from the personalized database D1 associated with the user. The positive code may be a positive code that implements a deep learning function, such as a positive code related to building or domain a deep learning model.

In operation S703, the negative code is searched. For example, the negative code matching the first descriptive text may be searched from the personalized database D1 associated with the user. Similarly, the negative code may be a negative code that implements a deep learning function, such as a negative code related to building or domain a deep learning model.

In operation S704, a second descriptive text is generated. Based on the prompt template, the second descriptive text may be generated according to the first descriptive text input in operation S701, the positive code searched in operation S702, and the negative code searched in operation S703.

In operation S705, a target code is output. The second descriptive text output in operation S704 is input into a large model M1, so as to output the target code.

In operation S706, it is determined whether to adopt the target code. The user may indicate whether he has adopted the target code by performing a first preference operation or a second preference operation on the target code. Correspondingly, the terminal device may determine whether the user has adopted the target code based on the interaction with the user. Operation S707 is proceeded when the user does not adopt the target code. Operation S708 is proceeded when the user adopts the target code.

In operation S707, a negative sample is formed. For example, the first descriptive text and the target code may be formed as the negative sample.

In operation S708, a cursor position and a code feature are recorded when the target code is adopted. The user may specify the editing position of the editing operation through the cursor, for example, the cursor position is the editing position. The code feature may be the number of lines of codes after the editing position when the editing operation begins.

In operation S709, the intermediate positive historical code is recorded when the editing operation is ended. For example, after a preset duration, it is determined that the user has ended the editing operation, and at this time, the intermediate positive historical code is recorded.

In operation S710, an editing code is determined. The editing code is determined according to the code feature and the intermediate positive historical code.

In operation S711, a positive sample is formed. For example, the positive sample may be formed by the first descriptive text and the editing code.

In addition, in operation S712, the text of knowledge in field is input, so as to complete an initialization operation on the personalized database D1 associated with the user. As the user continues to use the large model M1 and combine the positive and negative samples to supplement the personalized database D1, the effect of enhancing the code generation of the large model will become increasingly evident, thereby achieving more accurate and customized code generation.

Therefore, in the present disclosure, the code generation effect of the large model in the field of deep learning may be effectively enhanced in the self-feedback enhancement manner. At the same time, automatic description of deep learning user (developer) profiles may be achieved, and specific programming preferences and style requirements of the user may be met in a customized way, thereby effectively improving the user experience.

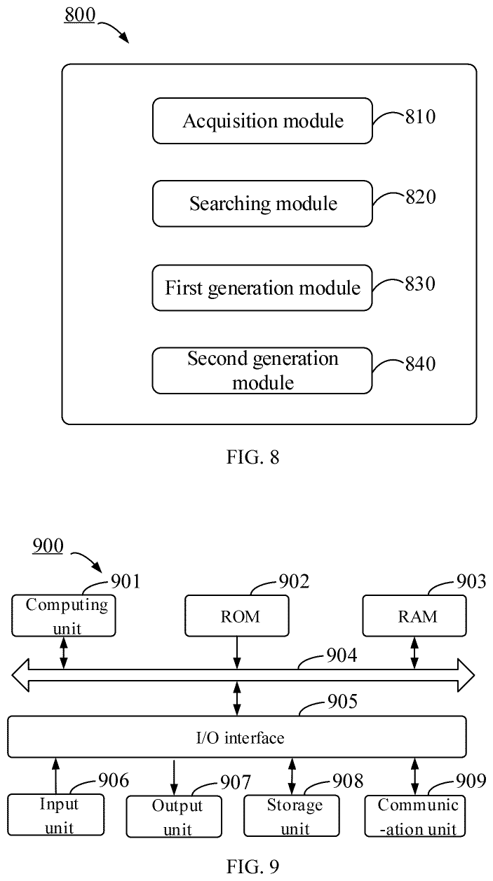

FIG. 8 schematically shows a block diagram of an apparatus of generating a code based on a large model according to the embodiments of the present disclosure.

As shown in FIG. 8, an apparatus 800 of generating a code based on a large model includes an acquisition module 810, a searching module 820, a first generation module 830 and a second generation module 840.

The acquisition module 810 is used to acquire a first descriptive text input by a user, where the first descriptive text is used to characterize a code requirement.

The searching module 820 is used to search for a positive code matching the first descriptive text and a negative code matching the first descriptive text, where each of the positive code and the negative code is determined based on a preference operation of the user for a historical code output by the large model.

The first generation module 830 is used to generate a second descriptive text according to the first descriptive text, the positive code, and the negative code.

The second generation module 840 is used to input the second descriptive text into the large model to output a target code matching the code requirement.

According to the embodiments of the present disclosure, the searching module includes a first searching sub-module, a first determination sub-module and a second determination sub-module.

The first searching sub-module is used to search for at least one historical descriptive text similar to the first descriptive text from a personalized database associated with the user.

The first determination sub-module is used to determine at least one initial positive code associated with the at least one historical descriptive text and at least one initial negative code associated with the at least one historical descriptive text.

The second determination sub-module is used to select at least one positive code and at least one negative code from the at least one initial positive code and the at least one initial negative code, respectively.

According to the embodiments of the present disclosure, the searching module further includes a second searching sub-module and a third determination sub-module.

The second searching sub-module is used to search for at least one positive sample similar to the first descriptive text and at least one negative sample similar to the first descriptive text from a personalized database associated with the user, according to a historical descriptive text and a code annotation text included in each of the positive sample and the negative sample.

The third determination sub-module is used to determine the positive code and the negative code according to a positive code included in each of the at least one positive sample and a negative code included in each of the at least one negative sample.

According to the embodiments of the present disclosure, the first generation module includes an acquisition sub-module and a combination sub-module.

The acquisition sub-module is used to acquire a first prompt word, a positive prompt word, and a negative prompt word.

The combination sub-module is used to combine, based on a prompt template, the first prompt word, the positive prompt word, the negative prompt word, the first descriptive text, the positive code, and the negative code to obtain the second descriptive text.

According to the embodiments of the present disclosure, the apparatus 800 of generating the code based on the large model further includes a third searching sub-module and an updating sub-module.

The third searching sub-module is used to search for a domain knowledge text matching the first descriptive text from the personalized database.

The updating sub-module is used to update the second descriptive text by using the domain knowledge text and a second prompt word.

According to the embodiments of the present disclosure, the apparatus 800 of generating the code based on the large model further includes a preference code determination module, and the preference code determination module includes a first selection sub-module, a second selection sub-module and a storage sub-module.

The first selection sub-module is used to determine the historical code as the negative code associated with the historical code according to a first preference selection operation of the user for the historical code.

The second selection sub-module is used to determine the historical code as the positive code associated with the historical code according to a second preference selection operation of the user for the historical code.

The storage sub-module is used to store the positive code and the negative code in a personalized database associated with the user.

According to the embodiments of the present disclosure, the preference code determination module further includes a fourth determination sub-module and an editing sub-module.

The fourth determination sub-module is used to determine the historical code determined based on the second preference selection operation as an initial positive historical code.

The editing sub-module is used to determine an editing code according to an editing operation of the user for the initial positive historical code, and determine the editing code as the positive code.

According to the embodiments of the present disclosure, the editing sub-module includes a first determination unit, an acquisition unit and a second determination unit.

The first determination unit is used to determine an editing position where the editing operation begins and determine a code feature of the initial positive historical code after the editing position.

The acquisition unit is used to acquire, in response to determining that the user ends the editing operation, an intermediate positive historical code at a time instant where the user ends the editing operation.

The second determination unit is used to determine the editing code according to the code feature and the intermediate positive historical code.

According to the embodiments of the present disclosure, the present disclosure further provides an electronic device, a readable storage medium and a computer program product.

According to the embodiments of the present disclosure, an electronic device is provided, including: at least one processor; and a memory communicatively connected to the at least one processor, where the memory stores instructions executable by the at least one processor, and the instructions, when executed by the at least one processor, cause the at least one processor to implement the method mentioned above.

According to the embodiments of the present disclosure, a non-transitory computer-readable storage medium having computer instructions stored thereon is provided, where the computer instructions are configured to cause a computer to implement the method mentioned above.

According to the embodiments of the present disclosure, a computer program product containing a computer program is provided, where the computer program, when executed by a processor, causes the processor to implement the method mentioned above.

FIG. 9 schematically shows a block diagram of an electronic device 900 used to implement the method of generating the code based on the large model according to the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the device 900 may include a computing unit 901, which may perform various appropriate actions and processing based on a computer program stored in a read-only memory (ROM) 902 or a computer program loaded from a storage unit 908 into a random access memory (RAM) 903. Various programs and data required for the operation of the device 900 may be stored in the RAM 903. The computing unit 901, the ROM 902 and the RAM 903 are connected to each other through a bus 904. An input/output (I/O) interface 905 is further connected to the bus 904.

Various components in the device 900, including an input unit 906 such as a keyboard, a mouse, etc., an output unit 907 such as various types of displays, speakers, etc., a storage unit 908 such as a magnetic disk, an optical disk, etc., and a communication unit 909 such as a network card, a modem, a wireless communication transceiver, etc., are connected to the I/O interface 905. The communication unit 909 allows the device 900 to exchange information/data with other devices through a computer network such as the Internet and/or various telecommunication networks.

The computing unit 901 may be various general-purpose and/or special-purpose processing components with processing and computing capabilities. Some examples of the computing unit 901 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 901 may perform the various methods and processes described above, such as the method of generating the code based on the large model. For example, in some embodiments, the method of generating the code based on the large model may be implemented as a computer software program that is tangibly contained on a machine-readable medium, such as the storage unit 908. In some embodiments, part or all of a computer program may be loaded and/or installed on the device 900 via the ROM 902 and/or the communication unit 909. When the computer program is loaded into the RAM 903 and executed by the computing unit 901, one or more steps of the method of generating the code based on the large model described above may be performed. Alternatively, in other embodiments, the computing unit 901 may be used to perform the method of generating the code based on the large model in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a special-purpose or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, and infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of generating a code based on a large model, comprising:
acquiring a first descriptive text input by a user, wherein the first descriptive text is configured to characterize a code requirement;
searching for a positive code matching the first descriptive text and a negative code matching the first descriptive text, wherein each of the positive code and the negative code is determined based on a preference operation of the user for a historical code output by the large model;
generating a second descriptive text according to the first descriptive text, the positive code, and the negative code; and
inputting the second descriptive text into the large model to output a target code matching the code requirement.

2. The method according to claim 1, wherein the searching for a positive code matching the first descriptive text and a negative code matching the first descriptive text comprises:
searching for at least one historical descriptive text similar to the first descriptive text from a personalized database associated with the user;
determining at least one initial positive code associated with the at least one historical descriptive text and at least one initial negative code associated with the at least one historical descriptive text; and
selecting at least one positive code and at least one negative code from the at least one initial positive code and the at least one initial negative code, respectively.

3. The method according to claim 1, wherein the searching for a positive code matching the first descriptive text and a negative code matching the first descriptive text comprises:
searching for at least one positive sample similar to the first descriptive text and at least one negative sample similar to the first descriptive text from a personalized database associated with the user, according to a historical descriptive text and a code annotation text comprised in each of the positive sample and the negative sample; and
determining the positive code and the negative code according to a positive code comprised in each of the at least one positive sample and a negative code comprised in each of the at least one negative sample.

4. The method according to claim 2, wherein the generating a second descriptive text according to the first descriptive text, the positive code, and the negative code comprises:
acquiring a first prompt word, a positive prompt word, and a negative prompt word; and
combining, based on a prompt template, the first prompt word, the positive prompt word, the negative prompt word, the first descriptive text, the positive code, and the negative code to obtain the second descriptive text.

5. The method according to claim 4, further comprising:
searching for a text of code field knowledge matching the first descriptive text from the personalized database; and
updating the second descriptive text by using the text of code field knowledge and a second prompt word.

6. The method according to claim 1, wherein the determining the positive code and the negative code comprises:
determining the historical code as the negative code associated with the historical code according to a first preference selection operation of the user for the historical code;
determining the historical code as the positive code associated with the historical code according to a second preference selection operation of the user for the historical code; and
storing the positive code or the negative code in a personalized database associated with the user.

7. The method according to claim 6, further comprising:
determining the historical code determined based on the second preference selection operation as an initial positive historical code; and
determining an editing code according to an editing operation of the user for the initial positive historical code, and determining the editing code as the positive code.

8. The method according to claim 7, wherein the determining an editing code according to an editing operation of the user for the initial positive historical code comprises:
determining an editing position where the editing operation begins and determining a code feature of the initial positive historical code after the editing position;
acquiring, in response to determining that the user ends the editing operation, an intermediate positive historical code at a time instant where the user ends the editing operation; and
determining the editing code according to the code feature and the intermediate positive historical code.

9. An electronic device, comprising:
at least one processor; and
a memory communicatively connected to the at least one processor, wherein the memory stores instructions executable by the at least one processor, and the instructions, when executed by the at least one processor, cause the at least one processor to:
acquire a first descriptive text input by a user, wherein the first descriptive text is configured to characterize a code requirement;
search for a positive code matching the first descriptive text and a negative code matching the first descriptive text, wherein each of the positive code and the negative code is determined based on a preference operation of the user for a historical code output by the large model;
generate a second descriptive text according to the first descriptive text, the positive code, and the negative code; and
input the second descriptive text into the large model to output a target code matching the code requirement.

10. The electronic device according to claim 9, wherein the at least one processor are further configured to:
search for at least one historical descriptive text similar to the first descriptive text from a personalized database associated with the user;
determine at least one initial positive code associated with the at least one historical descriptive text and at least one initial negative code associated with the at least one historical descriptive text; and
select at least one positive code and at least one negative code from the at least one initial positive code and the at least one initial negative code, respectively.

11. The electronic device according to claim 9, wherein the at least one processor are further configured to:
search for at least one positive sample similar to the first descriptive text and at least one negative sample similar to the first descriptive text from a personalized database associated with the user, according to a historical descriptive text and a code annotation text comprised in each of the positive sample and the negative sample; and
determine the positive code and the negative code according to a positive code comprised in each of the at least one positive sample and a negative code comprised in each of the at least one negative sample.

12. The electronic device according to claim 10, wherein the at least one processor are further configured to:
acquire a first prompt word, a positive prompt word, and a negative prompt word; and
combine, based on a prompt template, the first prompt word, the positive prompt word, the negative prompt word, the first descriptive text, the positive code, and the negative code to obtain the second descriptive text.

13. The electronic device according to claim 12, wherein the at least one processor are further configured to:
search for a text of code field knowledge matching the first descriptive text from the personalized database; and
update the second descriptive text by using the text of code field knowledge and a second prompt word.

14. The electronic device according to claim 9, wherein the at least one processor are further configured to:
determine the historical code as the negative code associated with the historical code according to a first preference selection operation of the user for the historical code;
determine the historical code as the positive code associated with the historical code according to a second preference selection operation of the user for the historical code; and
store the positive code or the negative code in a personalized database associated with the user.

15. The electronic device according to claim 14, wherein the at least one processor are further configured to:
determine the historical code determined based on the second preference selection operation as an initial positive historical code; and
determine an editing code according to an editing operation of the user for the initial positive historical code, and determining the editing code as the positive code.

16. The electronic device according to claim 15, wherein the at least one processor are further configured to:
determine an editing position where the editing operation begins and determining a code feature of the initial positive historical code after the editing position;
acquire, in response to determining that the user ends the editing operation, an intermediate positive historical code at a time instant where the user ends the editing operation; and
determine the editing code according to the code feature and the intermediate positive historical code.

17. A non-transitory computer-readable storage medium having computer instructions stored thereon, wherein the computer instructions are configured to cause a computer to:
acquire a first descriptive text input by a user, wherein the first descriptive text is configured to characterize a code requirement;
search for a positive code matching the first descriptive text and a negative code matching the first descriptive text, wherein each of the positive code and the negative code is determined based on a preference operation of the user for a historical code output by the large model;
generate a second descriptive text according to the first descriptive text, the positive code, and the negative code; and
input the second descriptive text into the large model to output a target code matching the code requirement.

18. The non-transitory computer-readable storage medium according to claim 17, wherein the computer instructions are further configured to cause the computer to:
search for at least one historical descriptive text similar to the first descriptive text from a personalized database associated with the user;
determine at least one initial positive code associated with the at least one historical descriptive text and at least one initial negative code associated with the at least one historical descriptive text; and
select at least one positive code and at least one negative code from the at least one initial positive code and the at least one initial negative code, respectively.

19. The non-transitory computer-readable storage medium according to claim 17, wherein the computer instructions are further configured to cause the computer to:
search for at least one positive sample similar to the first descriptive text and at least one negative sample similar to the first descriptive text from a personalized database associated with the user, according to a historical descriptive text and a code annotation text comprised in each of the positive sample and the negative sample; and
determine the positive code and the negative code according to a positive code comprised in each of the at least one positive sample and a negative code comprised in each of the at least one negative sample.

20. The non-transitory computer-readable storage medium according to claim 18, wherein the computer instructions are further configured to cause the computer to:
acquire a first prompt word, a positive prompt word, and a negative prompt word; and
combine, based on a prompt template, the first prompt word, the positive prompt word, the negative prompt word, the first descriptive text, the positive code, and the negative code to obtain the second descriptive text.
